(19) United States
(12) Patent Application Publication
(10) Pub. No.: US 2005/0001818 A1
(43) Pub. Date: Jan. 6, 2005

(54) Optic mouse

(75) Inventors: Wei Chang, San Chung City (TW); Hsien-Yeh Hung, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 10/610,767

(22) Filed: Jul. 2, 2003

(51) Int. Cl. G09G 5/08

(52) U.S. Cl. 345/166

(57) ABSTRACT

An optic mouse includes a housing having a bottom casing and a top cover mounted to the bottom casing, a circuit board mounted in the housing and a lens set mounted on the bottom casing. The bottom casing defines an opening. A detecting device is mounted to the circuit board and has a receiving portion in alignment with the opening of the bottom casing. A vertical cavity surface emitting laser source is arranged on one side of the detecting device. The lens set includes a convex lens having top and bottom faces respectively opposing the receiving portion of the detecting device and the opening of the bottom casing. The lens set further defines a channel in which a reflection member is formed. The channel has an open end opposing the vertical cavity surface emitting laser source for receiving optic signals from the laser source. By means of the optic characteristics of polarity of light emitted by the vertical cavity surface emitting laser source, together with the lens set, the light gets more convergent and does not diverge in traveling along an optic path from the laser source to the receiving portion of the detecting device whereby the operability of the mouse is enhanced.

### FIELD OF THE INVENTION

The present invention generally relates to an optic mouse, and in particular to an optic mouse comprising a Vertical Cavity Surface Emitting Laser (VCSEL) source for generation of a non-divergent light beam in position detection of the mouse.

### BACKGROUND OF THE INVENTION

Conventionally, a computer mouse comprises a bottom casing and a top cover mounted to the bottom casing, defining an interior space therebetween for accommodating a circuit board. The circuit board is fixed to the bottom casing and comprises a tracking module substantially aligned with an opening defined in the bottom casing. The tracking module comprises a track ball rotatably mounted inside the mouse and partially projects through the opening beyond the bottom casing for engaging a fixture surface on which the mouse is moved. The track ball is rotated when the mouse moves on the fixture surface. A cable is connected to the circuit board and has a free end extends out of the mouse casing and forming a connector with selective connection with a computer. The rotation of the track ball is converted into electrical signal that is transmitted through the cable to the computer for identification or detection of the position of the mouse, which is in turn converted into the position of a cursor on a display screen.

Due to the opening defined in the bottom casing, debris and dusts on the fixture surface may be drawn into the mouse by the rotation of the track ball that engages the fixture surface. This leads to poor engagement between components of the mouse in generating and transmission of the position signal of the mouse.

An optic mouse overcomes at least the dust problem by generating the movement signal of the mouse by means of detection of reflection light. The optic mouse comprises a bottom casing and a top cover attached to the bottom casing with a circuit board received between the bottom casing and the top cover and fixed to the bottom casing. A light emitting diode (LED) is mounted to the circuit board for projecting a light beam through an opening defined in the bottom casing. The light beam is reflected by a fixture surface on which the mouse is moved. The reflected light beam transmits through the opening of the casing, as well as a slot defined in the circuit board, and detected by a sensor mounted on the circuit board and substantially aligned with the opening. An optic arrangement is positioned between the circuit board and bottom casing, comprising first and second lenses that are integrally formed with and substantially perpendicular to each other. The first lens is in alignment with the light emitting diode, while the second lens corresponds in position to the sensor. A light beam projected from the light emitting diode is refracted by the first lens to the fixture surface and reflected by the fixture surface toward the second lens through which the reflected beam is detected by the sensor.

The conventional optic mouse effectively overcomes the dust problems of the mechanical mouse. However, the operation of the optic mouse is completely dependent upon the light beam from the light source (light emitting diode) and traveling along a path extending through the first lens, reflected by the fixture surface and then extending through the second lens before it is detected. Due to the optic characteristics of the light beam emitted by the light emitting diode, the light is emitted in a radiating manner from the light emitting diode. Such a light beam undergoes divergence during its travel along the light path through the first and second lenses. Thus the optic signal detected by the sensor is sometimes unstable and proper detection is impossible, making the sensor not properly detect the light beam reflected by the fixture surface and thus leading to poor operation of the optic mouse.

### SUMMARY OF THE INVENTION

Therefore, a primary object of the present invention is to provide an optic mouse comprising a vertical cavity surface emitting diode which gives off coherent light beam that does not diverge in traveling along a predetermined optic path, resulting in enhanced operability of the mouse.

To achieve the above object, in accordance with the present invention, there is provided an optic mouse comprising a housing having a bottom casing and a top cover mounted to the bottom casing, a circuit board mounted in the housing and a lens set mounted on the bottom casing. The bottom casing defines an opening. A detecting device is mounted to the circuit board and has a receiving portion in alignment with the opening of the bottom casing. A vertical cavity surface emitting laser source is arranged on one side of the detecting device. The lens set includes a convex lens having top and bottom faces respectively opposing the receiving portion of the detecting device and the opening of the bottom casing. The lens set further defines a channel in which a reflection member is formed. The channel has an open end opposing the vertical cavity surface emitting laser source for receiving optic signals from the laser source. By means of the optic characteristics of polarity of light emitted by the vertical cavity surface emitting laser source, together with the lens set, the light gets more convergent and does not diverge in traveling along an optic path from the laser source to the receiving portion of the detecting device whereby the operability of the mouse is enhanced.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of an optic mouse constructed in accordance with the present invention;

FIG. 2 is a cross-sectional view of a portion of the optic mouse in accordance with the present invention; and

FIG. 3 is a cross-sectional view similar to FIG. 2 and showing a light path of a light beam generated by the optic mouse.

### DETAILED DESCRIPTION OF THE PREFERRED EMBODIMENT

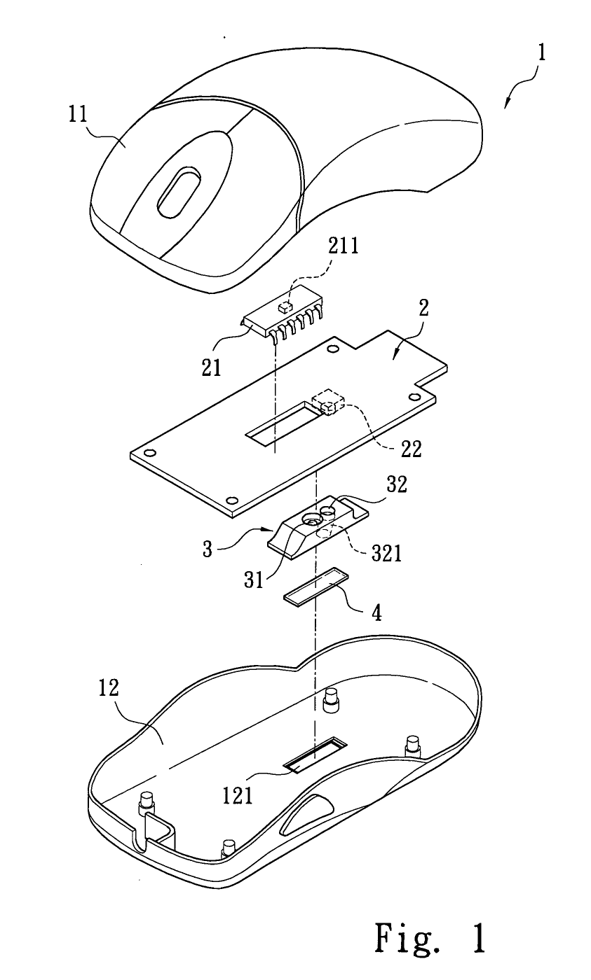

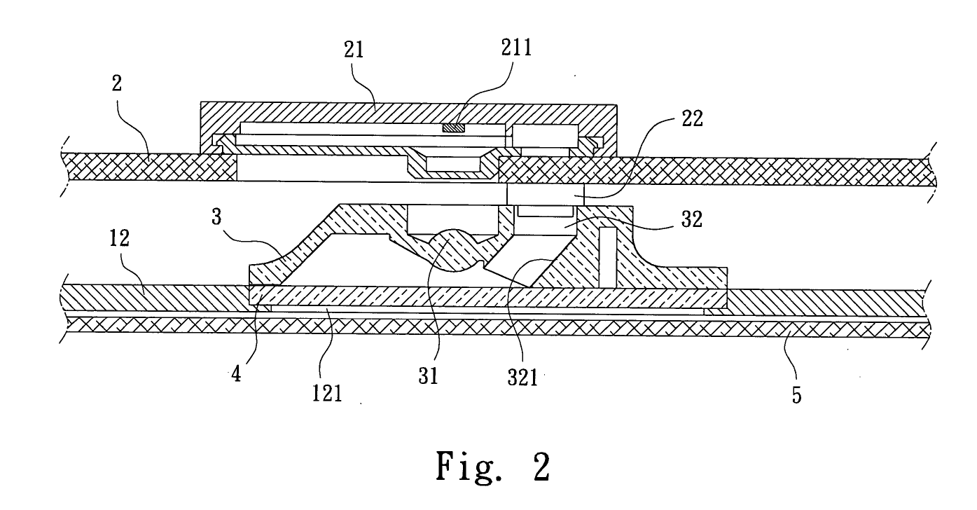

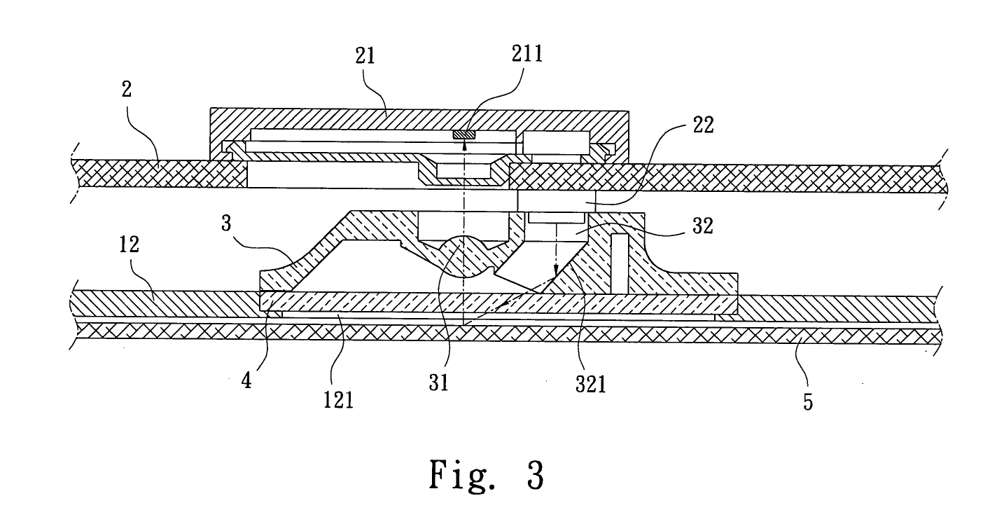

With reference to the drawings and in particular to FIGS. 1 and 2, an optic mouse constructed in accordance with the present invention comprises a housing 1 in which a circuit board 2 and a lens set 3 are mounted. The circuit board 2 comprises a vertical cavity surface emitting laser (VCSEL) light source 22 emitting a light beam having predetermined characteristics of polarity, which, together with the lens set 3, allows for excellent convergence of the light beam and eliminates divergence of the light when the light beam travels along an optic path as indicated by phantom lines shown in FIG. 3.

The housing 1 comprises a bottom casing 12 to which a top cover 11 is mounted, defining an interior space therebetween for accommodating the circuit board 2 and the lens set 3. The bottom casing 12 defines an opening 121.

The circuit board 2 is fixed in the housing 1. A detecting device 21 having a receiving portion 211 is mounted on the circuit board 2. The circuit board 2 further comprises electronic components and parts that allow for processing and manipulation of signals received by the receiving portion 211 for identifying the position of the mouse, which in turn controls the position of a cursor on a computer display screen (both not shown). The receiving portion 211 of the detecting device 21 is positioned in alignment with the opening 121. The VCSEL light source 22 is arranged at one side of the detecting device 21.

The lens set 3 is mounted to the bottom casing 12 of the housing 1, comprising a convex lens 31 having top and bottom faces respectively opposing the receiving portion 211 of the detecting device 21 and the opening 121 of the bottom casing 12. A channel 32 is defined in the lens set 3 adjacent the convex lens 31 having an open end opposing the VCSEL light source 22. A reflection member or surface 321 is formed inside the channel 32. The splitter 3 is positioned so that one side face of the splitter 3 is opposite to the laser source 22. An insulation plate 4 is interposed between the lens set 3 and the opening 121 for electrostatic insulation. The insulation plate 4 is made of light-transmitting materials, such as glass and clear plastics, to allow light emitted from the light source 22 to transmit therethrough and project onto a reflective fixture surface 5, such as a desk or a mouse pad.

Also referring to FIG. 3, an optic signal (the light beam) emitted from the VCSEL light source 22 travels into the channel 32 of the lens set 3 through the open end of the channel 32 and gets incident onto the reflection member 321. The reflection member 321 reflects the optic signal in a direction toward the opening 121 of the bottom casing 12. Thus, the optic signal transmits through the opening 121 toward the fixture surface 5, on which the mouse is moved. The optic signal is then reflected by the fixture surface 5 through the opening 121 and concentrated by the convex lens 31. The reflected optic signal transmits directly through the lens 31 and reaches the receiving portion 211 of the detecting device 21 and detected thereby. By means of the polarity characteristics of the optic signal from the VCSEL light source 22, together with the lens set 3, the optic signal emitted and reflected by traveling along the optic path gets more convergent and does not diverge thereby enhancing the operability of the mouse.

Although the present invention has been described with reference to the preferred embodiment thereof, it is apparent to those skilled in the art that a variety of modifications and changes may be made without departing from the scope of the present invention which is intended to be defined by the appended claims.

1. An optic mouse comprising:
a housing comprising a bottom casing and a top cover mounted to the bottom casing, the bottom casing defining an opening;
a circuit board received in the housing and comprising a detecting device having a receiving portion substantially aligned with the opening of the bottom casing, a vertical cavity surface emitting laser source being mounted at one side of the detecting device; and
a lens set mounted on the bottom casing of the housing, the lens set comprising a convex lens having top and bottom faces respectively opposing the receiving portion of the detecting device and the opening of the bottom casing, the lens set defining a channel in which a reflection member is formed, the channel having an open end opposing the vertical cavity surface emitting laser source for receiving an optic signal emitted from the vertical cavity surface emitting laser.

2. The optic mouse as claimed in claim 1 further comprising an insulation plate arranged between the opening and the lens set.

3. The optic mouse as claimed in claim 2, wherein the insulation plate comprises a glass plate.
